(19) United States
(12) Patent Application Publication
(10) Pub. No.: US 2017/0185279 A1
(43) Pub. Date: Jun. 29, 2017

(54) INFORMATION PROCESSING APPARATUS, INFORMATION PROCESSING METHOD, AND PROGRAM

(71) Applicant: CANON KABUSHIKI KAISHA, Tokyo (JP)

(72) Inventor: Tomonobu Hiraishi, Tokyo (JP)

(21) Appl. No.: 15/361,924

(22) Filed: Nov. 28, 2016

(30) Foreign Application Priority Data
Dec. 28, 2015 (JP) 2015-256997

(51) Int. Cl. G06F 3/0484; G06F 3/0485; G06F 17/30; G06F 3/0482

(52) U.S. Cl. CPC G06F 3/04847; G06F 3/0482; G06F 3/0485; G06F 17/30867; G06F 17/30554

(57) ABSTRACT

An information processing apparatus of the present invention displays a display image in which a plurality of contents are arranged. The information processing apparatus arranges and displays first contents out of a plurality of contents, which are contained in a first searching result that has been searched based on a first search condition, on a screen, further arranges and displays second contents out of the first contents, which are contained in a second searching result that has been searched based on a second search condition, on the screen, and selects at least one out of the second contents. After that, when the second search condition has been canceled, the information processing apparatus arranges and displays a part containing the contents that have been selected from among the second contents, out of the first contents, on the screen.

### BACKGROUND OF THE INVENTION

### Field of the Invention

The present invention relates to an information processing apparatus, an information processing method, and a program, which search a plurality of contents.

### Description of the Related Art

Conventionally, in order to search for a content which a user desires from among a plurality of contents, an information processing apparatus has been proposed that repeatedly executes a search by sequentially using a plurality of search conditions and narrows down a search range (see Japanese Patent Application Laid-Open No. 2011-60246). In addition, an information processing apparatus has been proposed that executes a search on a search condition which a client apparatus has requested through a Web browser, and displays detailed information on an item that has been selected from among the searching results, on the client apparatus (Japanese Patent Application Laid-Open No. 2012-53565). The information processing apparatus in Japanese Patent Application Laid-Open No. 2012-53565 performs search processing by using the next previous search condition, when a return button of a detailed view has been clicked that displays the detailed information on the content thereon, and transmits a list of the searching results to the client apparatus.

### SUMMARY OF THE INVENTION

However, in Japanese Patent Application Laid-Open No. 2011-60246 and Japanese Patent Application Laid-Open No. 2012-53565, the view which displays the searching result of the content has a limitation in a display range, and accordingly there is the case in which all of the searching results are not displayed in the view at a time. When a user has narrowed down a search range in stages, then canceled a part of the search condition, widened a search range and performed a search, the searching results increase, and accordingly there is a case where contents that have been displayed before the part of the search condition is canceled are hidden from a view of the list and are not displayed. In the case, the user performs a scroll operation and the like, and thereby the contents that have been displayed before the part of the search conditions is canceled are displayed at last. Thus, the user has needed to perform an operation for searching the contents which have received attention before the part of the search condition is canceled, in other words, the contents which have been displayed before the part of the search conditions is canceled.

An object of the present invention is to provide an information processing apparatus that can display contents to which a user has paid attention when having narrowed down a search range, even in a case where the information processing apparatus has recalled the search range after having narrowed down the contents in stages and has displayed the searching result again.

According to one exemplary embodiment of the present invention, an information processing apparatus includes: a processor; and a memory storing a program which, when executed by the processor, causes the information processing apparatus to: arrange and display a part of first contents out of the plurality of contents, which are contained in a first searching result that has been searched based on a first search condition, on a screen; arrange and display a part of second contents out of the first contents contained in the first searching result, which are contained in a second searching result that has been searched based on a second search condition, on the screen; select at least one out of the second contents which are contained in the second searching result; arrange and display a part containing the selected contents, out of the first contents which are contained in the first searching result, on the screen, if the second search condition is canceled; and update contents which are arranged on the screen, in response to scrolling.

The information processing apparatus according to the present invention, when a user has narrowed down a search range of contents in stages by using a plurality of search conditions, and canceled a part or all of the search conditions, displays a searching result that contains contents which have been displayed before the search conditions are canceled, on a display image. Thereby, it becomes easy for a user to find out the contents which the user pays attention to and those peripheral contents, and to utilize the contents.

Further features of the present invention will become apparent from the following description of exemplary embodiments with reference to the attached drawings.

### BRIEF DESCRIPTION OF THE DRAWINGS

FIG. 1 is a block diagram illustrating an overall configuration of an information providing system according to one embodiment of the present invention.

FIG. 2 is a block diagram illustrating a configuration of an information processing apparatus according to one embodiment of the present invention.

FIG. 3 is a flow chart illustrating processes which are performed in the information processing apparatus according to one embodiment of the present invention.

FIGS. 4A, 4B and 4C are views each illustrating one example of view displays according to one embodiment of the present invention.

FIG. 5 is a view illustrating one example of view displays according to one embodiment of the present invention.

FIG. 6 is a view illustrating one example of view displays according to one embodiment of the present invention.

FIGS. 7A and 7B are views each illustrating one example of view displays according to one embodiment of the present invention.

FIGS. 8A and 8B are views each illustrating one example of view displays according to one embodiment of the present invention.

FIGS. 9A and 9B are views each illustrating one example of view displays according to one embodiment of the present invention.

FIGS. 10A, 10B and 10C are views each illustrating one example of view displays according to one embodiment of the present invention.

FIG. 11 is a view illustrating one example of view displays according to one embodiment of the present invention.

FIGS. 12A, 12B, 12C and 12D are views each illustrating one example of view displays according to one embodiment of the present invention.

### DESCRIPTION OF THE EMBODIMENTS

Embodiments according to the present invention will be described in detail below with reference to the drawings. However, components described in this embodiment are just examples, and the scope of the present invention is not limited only to the components.

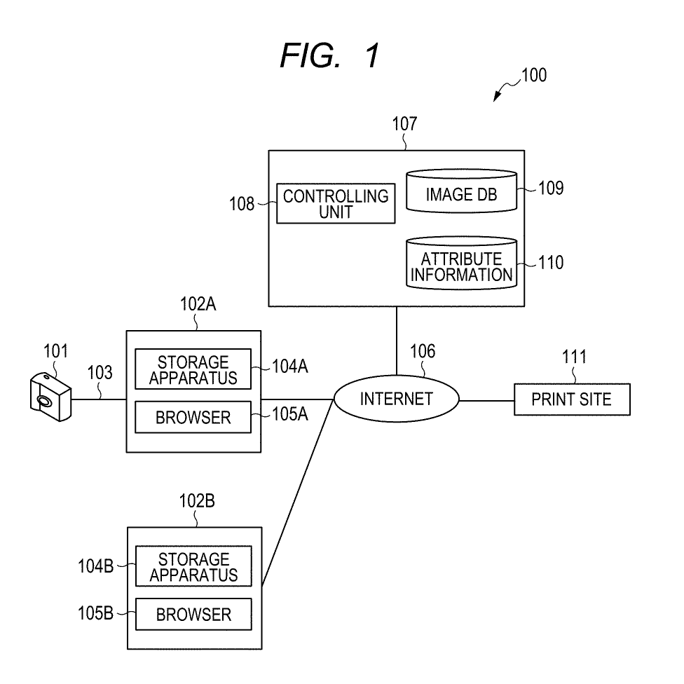

A configuration of an information providing system 100 according to the present embodiment will be described below. FIG. 1 is a block diagram illustrating an overall configuration of the information providing system 100 according to the present embodiment. The information providing system 100 is provided with an image input apparatus 101, user terminals 102A and 102B, a photosite 107 and a print site 111. The user terminals 102A and 102B, the photosite 107 and the print site 111 are connected so as to be capable of communicating with each other through the Internet 106. The image input apparatus 101 is an apparatus that can acquire still image data or moving image data, both of which are contents. The image input apparatus 101 is, for instance, a digital still camera that can photograph an object and record the photographed object as still image data, a digital video camera which can record the object as moving image data, a scanner which reads out an original and records the original as still image data, or the like. The image input apparatus 101 converts an optical image that is image information, into an electric signal, subjects the electric signal to predetermined image processing, and then records the processed optical image in a storage apparatus as digital information.

The user terminals 102A and 102B are apparatuses such as a PC (Personal Computer), a smart phone and a tablet terminal; and the user terminal 102A is a terminal which an owner user uses, and the user terminal 102B is a terminal which an invited user uses. The user terminal 102A is provided with a storage apparatus 104A and a browser 105A. The storage apparatus 104A is, for instance, an HDD (Hard Disk Drive). The browser 105A is an application that has a standard protocol such as an http protocol, which can transmit and receive data through the Internet 106, and communicates with the photosite 107 with the use of the standard protocol. The user terminal 102B has a similar configuration to that of the user terminal 102A, and is provided with a storage apparatus 104B and a browser 105B. In the present embodiment, the owner user is a user who transfers image data to the user terminal 102A from the image input apparatus 101, uploads the image data to the photosite 107 through the Internet 106, and creates an electronic album. The invited user is a user whom the owner user has invited, and is a user who can browse the electronic album which the owner user has disclosed. The user terminal 102A is connected to the image input apparatus 101 through an interface 103 for transferring data, and acquires the image data from the image input apparatus 101 through the interface 103 for transferring the data.

The interface 103 for transferring the data is an interface for transferring the image data which the image input apparatus 101 has input, to the user terminal 102A. The interfaces 103 for transferring the data is a wired interface such as a USB (Universal Serial Bus) and IEEE1394, or a wireless interface such as IrDA and Bluetooth (registered trademark). The image data that has been transferred to the user terminal 102A from the image input apparatus 101 through the interface 103 for transferring the data is stored in the storage apparatus 104A. The image data is transferred from the image input apparatus 101 to the user terminal 102A by an OS (Operating System) or a dedicated software that is installed in the user terminal 102A. Specifically, a CPU (Central Processing Unit) which acts as a controlling unit 201 of the user terminal 102A executes the OS or the dedicated software. Thereby, the controlling unit 201 reads out the image data that is stored in the storage apparatus (not shown) of the image input apparatus 101, and transfers the image data to the user terminal 102A. Alternately, according to a transfer command which the image input apparatus 101 has transmitted to the user terminal 102A, the controlling unit 201 of the user terminal 102A receives the image data sent from the image input apparatus 101 by the OS or the dedicated software, and stores the image data in the storage apparatus 104A.

The photosite 107 is provided with a controlling unit 108, an image database (hereinafter referred to as image DB) 109, and an attribute information database (hereinafter referred to as attribute information DB) 110. The controlling unit 108 reads out a control program stored in the not-shown storage apparatus, executes the control program, and controls each unit in the photosite 107. The controlling unit 108 controls each of the units so as to transmit the image data which the owner user has selected in the browser 105A, to the photosite 107, in response to a request to upload. In the image DB 109, the image data is stored that has been uploaded to the photosite 107. In the attribute information DB 110, various data are collectively managed such as attribute information on the image data that is registered in the image DB 109, attribute information on a user who is registered in the photosite 107, and attribute information on the print site 111. The print site 111 subjects the image data to print processing with the use of a not-shown printer. Incidentally, in FIG. 1, only one print site 111 is displayed, but there may exist a plurality of print sites 111.

Next, uploading of the image data by the user terminal 102A will be described below. The browser 105A of the user terminal 102A accesses the photosite 107 by using the standard protocol such as the http protocol. The browser 105A displays information that is linked to multimedia information which the photosite 107 manages, such as an image and a voice that have been created by a description language such as HTML and XML. Thereby, the user terminal 102A can receive a service of using the Internet 106 as a communication infrastructure which the photosite 107 provides. Next, the image data that is stored in the storage apparatus 104A of the user terminal 102A is uploaded to the photosite 107, by an operation of the owner user. The owner user uploads the image data, for instance, by selecting an image which the owner user wants to upload through the browser 105A.

The controlling unit 108 checks that the image data which has been uploaded to the photosite 107 is available data to the photosite 107. The controlling unit 108 reads out a control program that is stored in a not-shown memory, executes the control program, and thereby processes the uploaded image data. When the data is available image data to the photosite 107, the controlling unit 108 stores the uploaded image data in the image DB 109, and stores the attribute information and the like in the attribute information DB 110. In this stage, the controlling unit 108 notifies the user terminal 102A that the image data has been normally uploaded. The owner user can view the uploaded image data through the browser 105A. There is a case where the uploaded image data is managed as an electronic album in which a plurality of sheets are combined, and in this case, the owner user can browse the electronic album. In addition, the controlling unit 108 can disclose the image data to a third party, as the electronic album, and the invited user can browse these images by accessing the photosite from the user terminal 102B of the invited user. In addition, the owner user or the invited user can also transfer the image data of an image that the user has selected in the photosite 107 to the print site 111, and print the transferred image data there. The disclosure of the image data to the third party and the printing order thereof are examples for utilizing the image data in the photosite 107, and the utilization example is not limited to these examples. In addition, a method for achieving the disclosure of the image data to the third party and the printing order thereof do not limit the present invention, and may be any method.

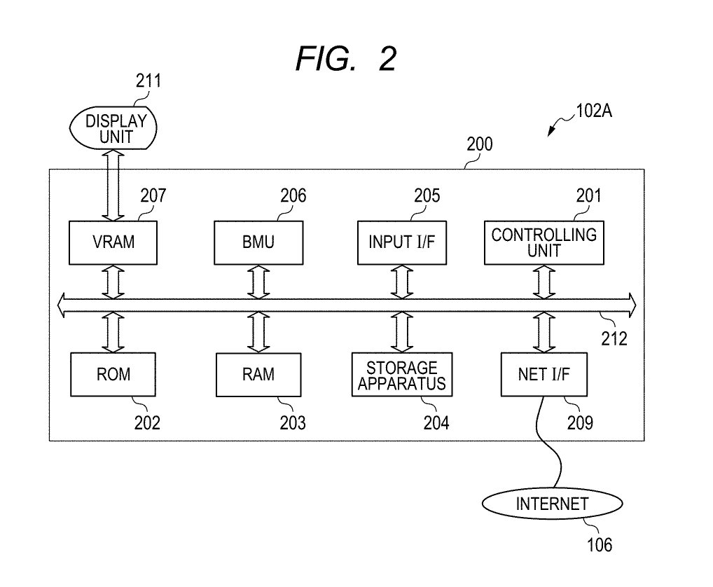

A configuration of an information processing apparatus 200 according to the present embodiment will be described below. FIG. 2 is a block diagram illustrating the configuration of the information processing apparatus 200 of the user terminal 102A according to the present embodiment. Incidentally, the information processing apparatus 200 may be implemented by a single computer apparatus, or may also be implemented by dispersing each function to a plurality of computer apparatuses, as needed. When the information processing apparatus 200 is structured by the plurality of computer apparatuses, the computer apparatuses are connected to each other by a communication line such as LAN (Local Area Network) so that the apparatuses can communicate with each other.

The information processing apparatus 200 is provided with a controlling unit 201, a ROM (Read Only Memory) 202, a RAM (Random Access Memory) 203, a storage apparatus 204, and an input interface (hereinafter referred to as input I/F) 205. In addition, the information processing apparatus 200 is provided with a BMU (Bit Move Unit) 206, a VRAM (Video RAM) 207, and a network interface (hereinafter referred to as network I/F) 209. The controlling unit 201 which acts as a first arranging unit, a second arranging unit and a third arranging unit controls the whole information processing apparatus 200. In addition, the controlling unit 201 controls each of the units in the information processing apparatus 200, by executing the control program that is stored in the ROM 202 or the storage apparatus 204.

The ROM 202 stores various control programs and various parameters therein. The RAM 203 temporarily stores a control program, data and the like therein that are supplied from the ROM 202 or the storage apparatus 204. In addition, the RAM 203 temporarily stores a control program, data and the like therein that are supplied through the Internet 106. The storage apparatus 204 is a hard disk, a memory card or the like that is provided integrally with the information processing apparatus 200, and stores a program of the OS (Operating System) and the like therein. Incidentally, the storage apparatus 204 stores the control program of the photosite 107 of the present embodiment therein, and stores contents therein such as an image file that has been created by an image pickup apparatus and the like, and an image file which the information processing apparatus has acquired from the image input apparatus 101.

An input I/F 205 is an interface to an input device such as a pointing device and a keyboard, which receives the operation of the user and inputs data. Incidentally, the input device is not limited to the interface, but may be a touch panel that has a touch sensor provided on the display unit 211. A BMU 206 controls data transfer, for instance, among memories (for instance, between VRAM 207 and another memory), and among a memory and each I/O device (for instance, network I/F 209). The VRAM 207 holds the image data for being displayed on the display unit 211. The image data that has been held in the VRAM 207 is transmitted to the display unit 211 according to predetermined timing, and thereby the image data is displayed on the display unit 211. The network I/F 209 is connected to the network line such as the Internet 106, and performs communication with an external apparatus that can communicate with the information processing apparatus. The controlling unit 201, the ROM 202, the RAM 203, the storage apparatus 204, the input I/F 205, the BMU 206, the VRAM 207 and the network I/F209 are connected to a system bus 212, and read from and write in each other through the system bus 212.

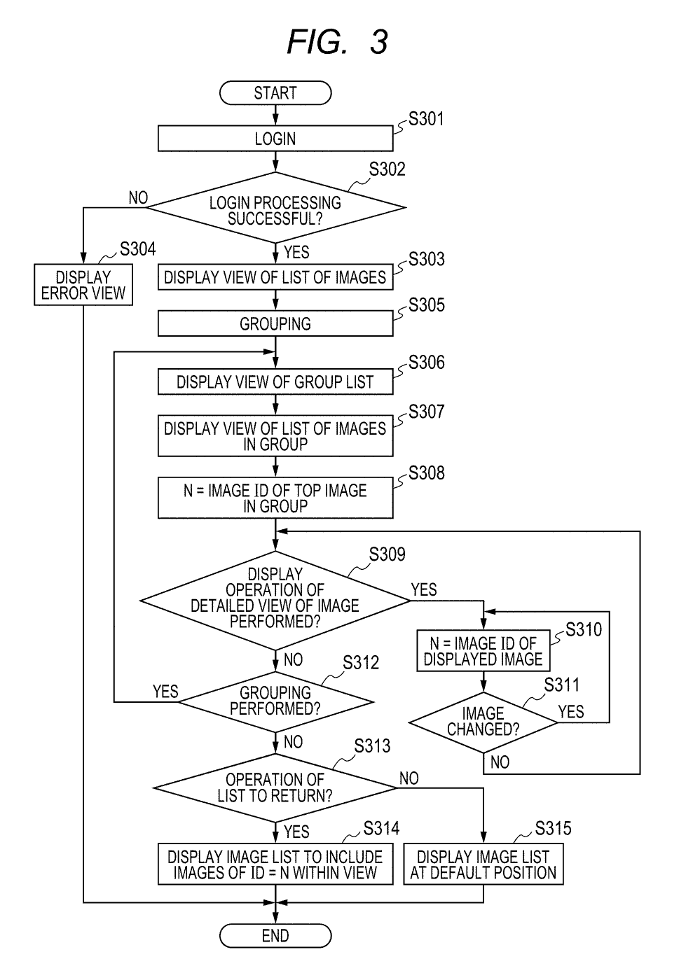

Next, the processing that is performed in the information processing apparatus 200 of the user terminal 102A in the present embodiment will be described below with reference to FIG. 3. FIG. 3 is a flow chart illustrating the processing that is performed in the information processing apparatus 200 according to the present embodiment. The processing that will be described below is executed by the controlling unit 201 in the information processing apparatus 200, which reads out an application program for the photosite 107 from the storage apparatus 204, and executes the application program. Incidentally, a person who uses the information processing apparatus 200 is the owner user who will be described as a user below. In addition, a view 400 of a list of images, a view 600 of a group list, a view 700 of a list of images in a group and a detailed view 1000 of an image, which are display images that will be described below, are views that are displayed on the browser 105A.

In a step S301, the controlling unit 201 performs login processing, in response to a login operation of a user in a login view (not-shown) of the photosite 107. The login operation is performed, for instance, by the inputs of an ID and a password in the login view by the user, which are peculiar to the user. The controlling unit 108 of the photosite 107 receives the ID and the password that have been input, from the information processing apparatus 200 through the Internet 106, and performs authentication processing. The controlling unit 108 of the photosite 107 compares the input ID and the password with an ID and a password in the attribute information on the user, which is managed in the attribute information DB 110, for instance, as the authentication processing. The controlling unit 108 of the photosite 107 transmits a result of the authentication processing that the login has been permitted, when the ID and the password which the controlling unit 108 has received exist in the attribute information DB 110, and transmits a result that the login is not permitted, when the ID and the password do not exist, to the information processing apparatus 200 through the Internet 106. Incidentally, the login processing is not limited to this login processing. In a step S302, the controlling unit 201 determines whether or not the login processing has succeeded. Specifically, the controlling unit 201 determines the login processing, based on the authentication result which the controlling unit 201 has received from the photosite 107. When the login processing has succeeded (step S302: Yes), the controlling unit 201 displays the view 400 of the list of images on the display unit 211 (step S303). In the step S303, the controlling unit 201 generates display data for the view 400 of the list of the images, and displays the generated display data on the display unit 211. Specifically, the controlling unit 201 acquires all of the image data which has been uploaded by the user and is managed in the image DB 109 of the photosite 107, from the photosite 107 through the Internet 106, and stores the image data in the storage apparatus 204. The controlling unit 201 generates display data for the view 400 of the list of the images, in which the image data is arranged in the view 400 of the list of the images, and displays the generated view 400 of the list of the images on the display unit 211.

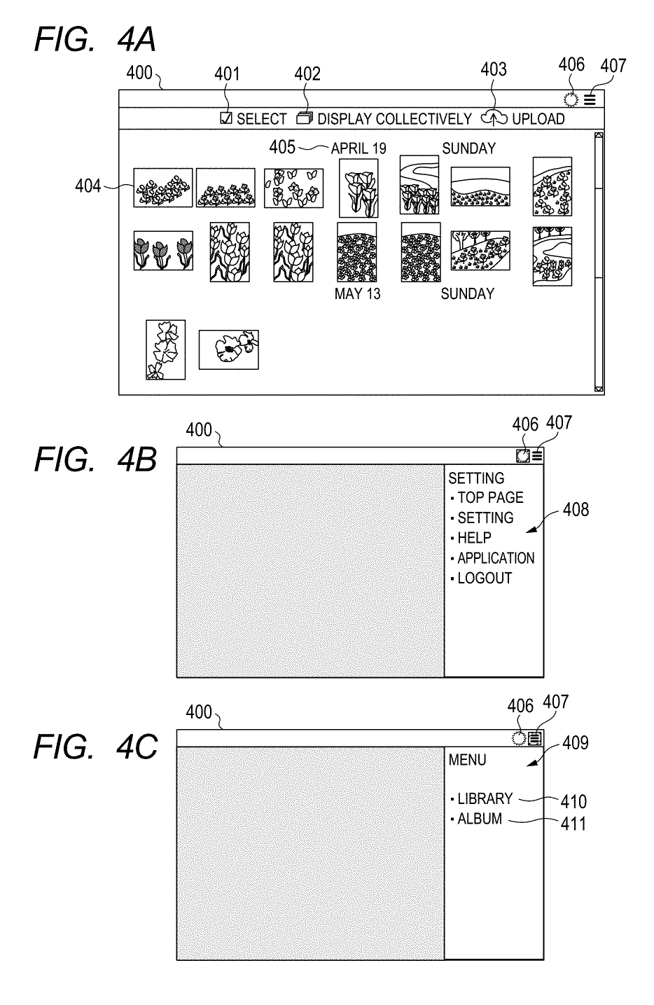

The view 400 of the list of the images will be described below with reference to FIGS. 4A to 4C. FIGS. 4A to 4C are views each illustrating one example of view displays according to the present embodiment. FIG. 4A is one example of the view 400 of the list of the images, which is displayed on the information processing apparatus 200 according to the present embodiment. FIG. 4B is one example of a setting menu 408 in the view 400 of the list of the images, according to the present embodiment. FIG. 4C is one example of a library/album menu 409in the view 400 of the list of the images, according to the present embodiment. The view 400 of the list of the images displays a selecting button 401, a grouping button 402, an upload button 403, a thumbnail 404, a photographed date 405, a setting menu display button 406 and the switching menu display button 407.

The selecting button 401 is a (not-shown) button for switching the view to a view on which the user can select an image that is displayed in the view 400 of the list of the images, and for displaying a switched view on which the user can select the image. The user can subject the selected image to a predetermined operation; and can create, for instance, an electronic album from the image data of the selected image, transmit the image data of the selected image to the print site 111, and order printing. The grouping button 402 is a button for displaying the menu for selecting the items that group the images. The upload button 403 is a button for displaying a view (not shown) on which the user additionally uploads the image data to the image that is managed in the image DB 109.

The thumbnail 404 is a thumbnail that has been formed of the image data which is uploaded in the photosite 107; and the images are classified according to each of the photographed dates 405, and are arranged and displayed in a tile shape on the view 400 of the list of the images. Incidentally, a method for displaying an image is not limited to this display method. The setting menu display button 406 is a button for displaying the setting menu 408 so as to be illustrated in FIG. 4B. The switching menu display button 407 is a button for displaying a library/album menu 409 so as to be illustrated in FIG. 4C. The controlling unit 201 switches the view display to a library 410 or an album 411 which manages all of the image data of the user, according to selection of the user in the library/album menu 409. The album 411 is a view, for instance, in which the images that have been selected on the view displayed by the selecting button 401 are collectively displayed.

When the login processing has failed (step S302: No), the controlling unit 201 displays an error view on the display unit 211 (step S304). In the step S304, the controlling unit 201 generates the display data for the not-shown error view, displays the display data on the display unit 211, and ends the present flow chart. In a step S305, the controlling unit 201 displays a grouping menu 501 for grouping the images which are displayed in the view 400 of the list of the images, when having detected the depression of the grouping button 402 in the view 400 of the list of the images.

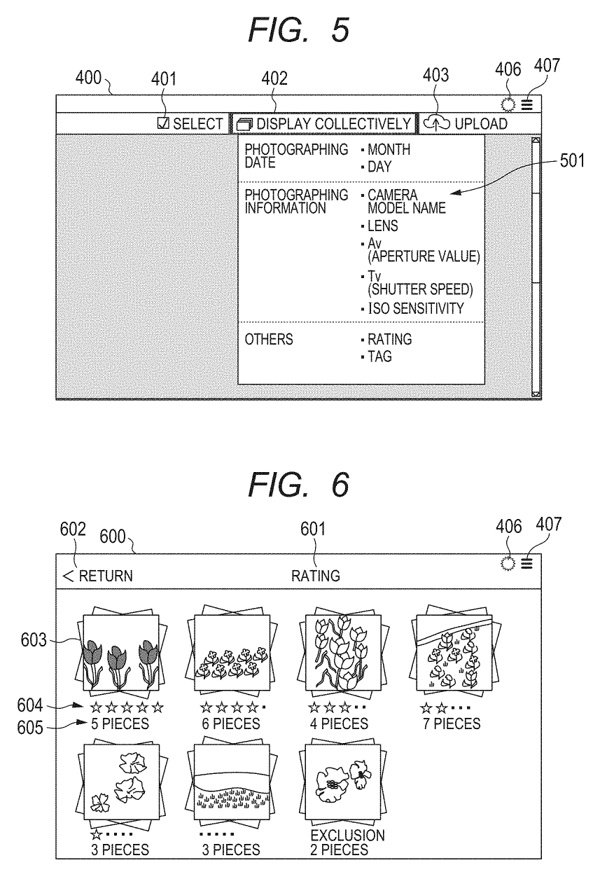

The grouping menu 501 will be described in detail below with reference to FIG. 5. FIG. 5 is a view illustrating one example of view displays according to the present embodiment. When the grouping button 402 is depressed, the grouping menu 501 is thereby displayed that is a first search condition and a second search condition. In the present embodiment, the grouping menu 501 displays the photographing date, the photographing information and other items, as items that can group the images. In addition, the item of the photographing date has detailed items of a photographing month and a photographing day; the item of the photographing information has detailed items of a camera model name, a lens, an aperture value, a shutter speed and an ISO sensitivity; and the other item has detailed items of a rating and a tag. The items of the grouping menu 501 are items which indicate the classification of the detailed items, and the detailed items are items which the user can select. Incidentally, the items that are displayed in the grouping menu 501 are not limited to the items, as long as the items are data which are stored in the attribute information DB 210. In addition, the rating is an image evaluation value (for instance, six-stage values of 0 to 5) which is input by the user.

The controlling unit 201 transmits an item that has been selected from among the detailed items of the grouping menu 501, to the photosite 107 through the Internet 106. The controlling unit 108 of the photosite 107 groups images that constitute the image data which the user has uploaded, according to the item that the controlling unit 108 has received, and transmits the data of the grouped result to the controlling unit 201 through the Internet 106. The controlling unit 201 stores the data of the grouped result in the storage apparatus 204. Incidentally, in the present embodiment, a grouping method is employed which groups the images under the same item, as an optimal example of narrowing down the image data, but the narrowing method may be a searching method by inputting character strings, and the narrowing method does not limit the present invention. In addition, the view 400 of the list of the images illustrated in FIG. 5 is set as a view in which the grouping menu 501 is extended by the grouping button 402, but a display method concerning the grouping is not limited to this display method. In addition, the form of the data of the result of the grouping, which the controlling unit 201 acquires from the photosite 107, may be the form of the data, by which the controlling unit 201 can discriminate between the respective images that have been grouped in the photosite 107.

In a step S306, the controlling unit 201 generates the view 600 of the group list, in which the image data is arranged that is the result produced by the grouping in the step S305, and displays the view 600 of the group list on the display unit 211. The view 600 of the group list will be described below with reference to FIG. 6. FIG. 6 is a view illustrating one example of view displays according to the present embodiment. The view 600 of the group list displays an item name 601, a return button 602, a thumbnail 603, a common item 604, the number of sheets 605, the setting menu display button 406 and the switching menu display button 407. The item name 601 is an item that has been selected in the grouping menu 501 of the view 400 of the list of the images. In the present embodiment, the image data that is displayed in the view 400 of the list of the images is grouped by the item of the rating which has been selected in the grouping menu 501, and accordingly “rating” is displayed in the item name 601.

The return button 602 is a button for returning the view to the last view, and when the return button 602 is depressed, the view is thereby returned to a view of the transition origin of the view 600 of the group list. The view 600 of the group list illustrated in FIG. 6 is a view for displaying the image data produced by the grouping in the first stage in the view 400 of the list of the images, and accordingly when the user depresses the button 602, the views returns to the view 400 of the list of the images on which all of the images are displayed. When the return button 602 has been depressed in the view 600 of the group list in which the image data produced by the grouping of an X-th stage is displayed, the view 700 of the list of the images in the group of an X-1st stage is displayed.

The thumbnail 603 is a thumbnail of a leading image in the images which have been grouped. Incidentally, grouping is different from searching, and does not end in that there is no corresponding item in the predetermined image data, and accordingly as a result of having been grouped, there does not exist an item in which there is no image data, and the thumbnail 603 is surely displayed in each of the items. The common item 604 is a name of a common item of the group. In FIG. 6, the images are grouped by the item of the rating, and accordingly are divided into seven groups in total, which include groups that have star icons of 0 to 5 and groups of exclusion, which have no star icon. The number of sheets 605 is the number of the image data that exist in each of the groups; as a result of having been grouped similarly to the thumbnail 603, there does not exist an item in which there is no image data; and accordingly one or more image data result in existing in each of the items.

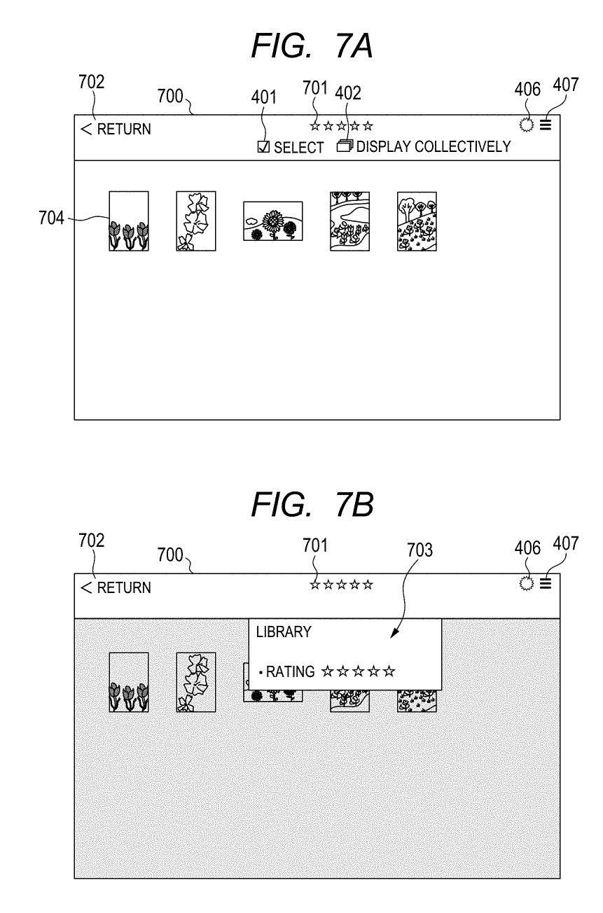

In a step S307, when the user has depressed the thumbnail 603 of the group which the user wants to display a list of the images, the controlling unit 201 generates display data of the view 700 of the list of the images in the group, and displays the display data on the display unit 211. Specifically, the controlling unit 201 generates the view 700 of the list of the images in the group, in which the image data of the group selected by the user is arranged, and displays the view on the display unit 211. The view 700 of the list of the images in the group will be described below with reference to FIGS. 7A and 7B. FIGS. 7A and 7B are views each illustrating one example of view displays according to the present embodiment. FIG. 7A is a view illustrating one example of the view 700 of the list of the images in the group according to the present embodiment; and FIG. 7B is a view illustrating one example of a list in the view 700 of the list of the images in the group according to the present embodiment. As is illustrated in FIG. 7A, the view 700 of the list of the images in the group displays an item name 701, a return button 702, a selecting button 401, a grouping button 402, a thumbnail 704, the setting menu display button 406 and the switching menu display button 407.

The item name 701 is a group name of a group that contains the thumbnail 603 which has been selected by the view 600 of the group list. FIG. 7A illustrates the view 700 of the list of the images in the group, which is displayed when the user has depressed the thumbnail 603 of the group that has five star icons in the view 600 of the group list, and the item in which five star icons are aligned is displayed as the item name 701. When the user depresses the item name 701, a history of the items which the user has narrowed down by grouping the whole images is displayed as a list 703, as is illustrated in FIG. 7B. The items that are displayed in the list 703 are items which have been selected by the grouping menu 501, and are stored in the storage apparatus 204. In the present embodiment, in the list 703, a link of the items is displayed in order of the items that have been selected in the grouping menu 501. The user can return to the view 700 of the list of the images in the group, which shows the result in which the user has narrowed down images by the selected item, by depressing an item that is displayed in the list 703. When the return button 702 is depressed, the view 700 thereby returns to the view 600 of the group list, which is the transition origin and is the last view.

The grouping button 402 is arranged in the view 700 of the list of the images in the group, and thereby the user can further narrow down images, while assuming all of the images which the user has narrowed down by grouping, as the parameter. In addition, by reducing the parameter, it becomes easy for the user to reach a target image, in other words, an image which the user wants to search. Incidentally, in the view 700 of the list of the images in the group, when the user can additionally upload an image, the uploaded image data is not displayed in the view 700 of the list of the images in the group, unless the image data is image data that belongs to the group corresponding to the item name 701. In this case, there is a possibility that the user gets confused. For this reason, in the present embodiment, the upload button 403 of the view 400 of the list of the images is not arranged in the view 700 of the list of the images in the group.

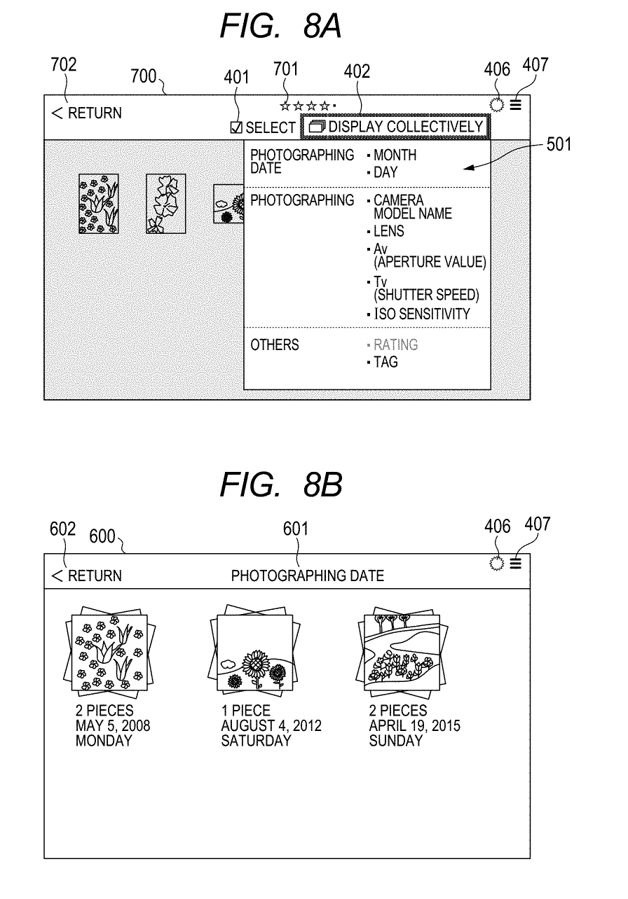

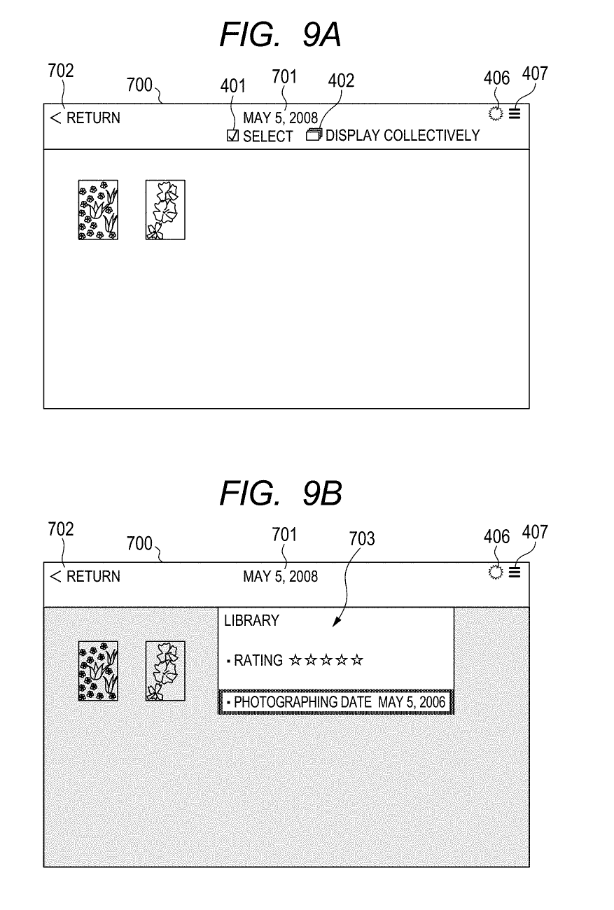

FIGS. 8A and 8B, and FIGS. 9A and 9B are views each illustrating one example of view displays according to the present embodiment. FIG. 8A is a view illustrating one example of states in which the user has depressed the grouping button 402 in the view 700 of the list of the images in the group in FIG. 7A. FIG. 8B is one example of the view 600 of the group list, in which the images have been grouped according to an item that has been selected in FIG. 8A. FIG. 9A is a view illustrating one example of a view 700 of the list of the images in the group, which displays image data of a group that has been selected in FIG. 8A. FIG. 9B is a view illustrating one example of a list 703 in the view 700 of the list of the images in the group, which is displayed in FIG. 9A. FIG. 8A, FIG. 8B, FIG. 9A and FIG. 9B illustrate the results produced by the grouping of the image in the second stage in the present embodiment, which the controlling unit 201 has performed in the steps S311, S306 and S307.

In FIG. 8A, in the view 700 of the list of the images in the group illustrated in FIG. 7A, the user selects an item which the user next adds to the search condition, in other words, an item for narrowing down the image, from the grouping menu 501. In the present embodiment, the rating is selected in the first stage, accordingly in FIG. 8A, the rating is in a state of being incapable of being selected, and the user selects an item other than the rating. The controlling unit 201 groups the image data that is displayed in FIG. 8A, according to the selected item. The controlling unit 201 generates a view 600 of the group list, which displays the image data of a result of the grouping performed in the second stage, and displays the view 600 of the group list, as is illustrated in FIG. 8B. In the present embodiment, the photographing day is selected from among the items of the grouping menu 501, the images are thereby grouped, as a result, the view 600 of the group list is displayed, which displays the image data grouped by the photographing day, and “photographing day” is displayed in the item name 601, as are illustrated in FIG. 8B. When the user selects one group from the view 600 of the group list illustrated in FIG. 8B, the view 700 of the list of the images in the group is displayed as is illustrated in FIG. 9A. In the present embodiment, the group of May 5 in 2008 has been selected in the view 600 of the group list illustrated in FIG. 8B, in which the images have been grouped by the photographing day, and as a result, “May 5 in 2008” is displayed in the item name 701 in the view 700 of the list of the images in the group, which is illustrated in FIG. 9A. In the present embodiment, the images are narrowed down by such multistage grouping as the rating in the first stage and the photographing day in the second stage, and accordingly when the list 703 is pushed down in FIG. 9A, also the list 703 is displayed in the multistage, as is illustrated in FIG. 9B.

In a step S308, the controlling unit 201 assigns a value of the image ID of the leading image that is displayed in the view 700 of the list of the images in the group, to a variable N. The image ID is an ID which can discriminate between the respective image data, and the different image IDs are appended to all of the image data, respectively. In a step S309, the controlling unit 201 determines whether or not an operation has been performed that displays a detailed view 1000 of the image, in the view 700 of the list of the images in the group. Specifically, the controlling unit 201 determines whether or not the user has depressed the thumbnail 404 in the view 700 of the list of the images in the group. When the operation of displaying the detailed view 1000 of the image has been performed, in other words, when the thumbnail 704 has been depressed in the view 700 of the list of the images in the group (step S309: Yes), the controlling unit 201 generates display data of the detailed view 1000 of the image, and displays the display data on the display unit 211. In a step S310, the controlling unit 201 assigns a value of the image ID of the displayed image, to the variable N. In the step S311, the controlling unit 201 determines whether or not the image has been switched which is displayed in the detailed view 1000 of the image. When the image has been switched which is displayed in the detailed view 1000 of the image (step S311: Yes), the controlling unit 201 assigns the image ID of the switched image, to the variable N. Thus, the image ID of the variable N is overwritten by an image ID of the image that has been newly selected. When the image has not been switched which is displayed in the detailed view 1000 of the image (step S311: No), the controlling unit 201 determines the presence or absence of the display operation of the detailed view 1000 of the image (step S309).

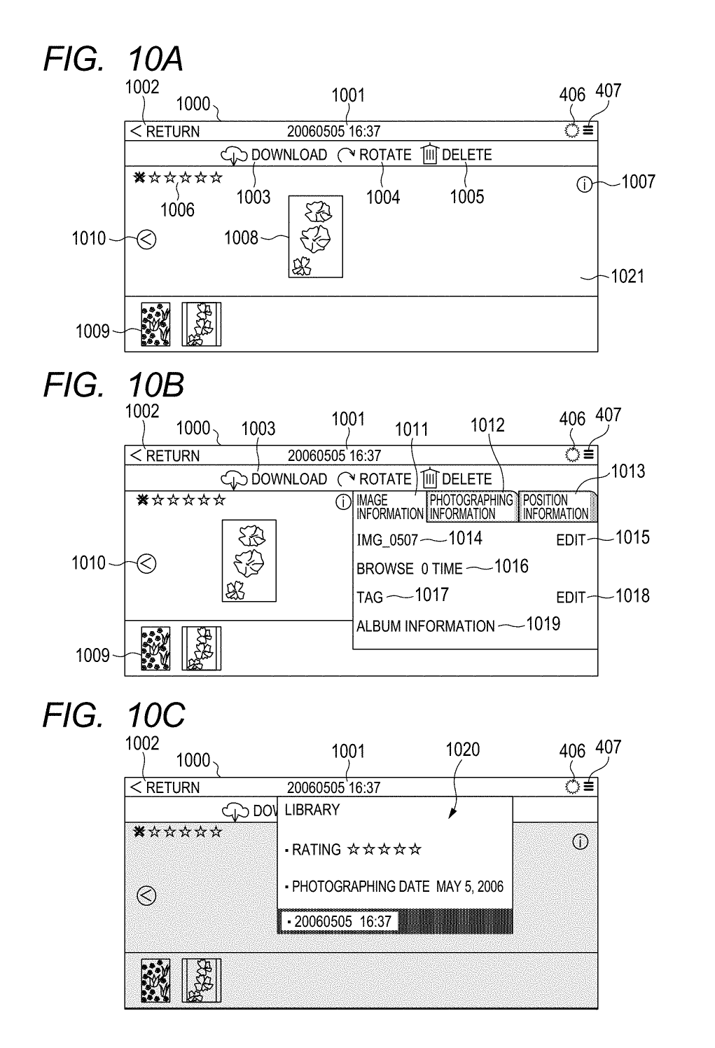

The detailed view 1000 of the image will be described below with reference to FIGS. 10A to 10C. FIGS. 10A to 10C are views each illustrating one example of image displays according to the present embodiment. FIG. 10A is a view illustrating one example of the detailed view 1000 of the image according to the present embodiment; FIG. 10B is a view illustrating one example of display of detailed information of the image according to the present embodiment; and FIG. 10C is a view illustrating one example of the list in the detailed view 1000 of the image in FIG. 10A. As is illustrated in FIG. 10A, the detailed view 1000 of the image displays a title 1001, a return button 1002, a download button 1003, a rotation button 1004, a deletion button 1005, a rating setting region 1006, and a detailed information display button 1007. In addition, the detailed view 1000 of the image displays a thumbnail 1008, a display region 1009 of images in a group, an image switching button 1010, and a display region 1021 of images.

The title 1001 is a title of the detailed view 1000 of the image. In the present embodiment, the title 1001 is the photographing date, but the title is not limited to the photographing date, and may also be a file name of the image of the thumbnail 1008. As for the title 1001, when the title 1001 is depressed, a list 1020 illustrated in FIG. 10C is thereby displayed, similarly to the item name 701 in the view 700 of the list of the images in the group. In the list 1020, the process by which the user has narrowed down the whole image in the multistage is displayed as the history, similarly to the list 703 illustrated in FIG. 7B. Then, when the item in the list 1020 is depressed, the view 700 of the list of the images in the group in the selected stage can be thereby displayed.

The return button 1002 is a button for returning to the last view, and when the return button is depressed, the view thereby returns to the view 700 of the list of the images in the group, which is the transition origin. The download button 1003 is a button for downloading the image data. When the download button 1003 is depressed, the original image data can be thereby downloaded that displays the thumbnail 1008. As for a method for downloading the image data, when using a browser of a PC, the user downloads the image data by using the browser function, and when using a smart phone, a tablet terminal or the like, the user downloads the image data to the storage apparatus 204 or the like, by using the dedicated application or the like. The method for downloading the image data is not limited to the above method, and the original image data may be copied into the storage apparatus 204.

The rotation button 1004 is a button for rotating the image. When the rotation button 1004 is depressed, the thumbnail 1008 thereby rotates to a designated direction, and the result is reflected in the original image data of the thumbnail 1008. As for a rotation method, the user may rotate the image uniformly to a right direction by 90 degrees, by depressing the rotation button 1004, or may select or input the rotation angle. The method is not limited to the above rotation method. In addition, the rotation of the image may be reflected to the original image data in real time, or the controlling unit 108 may apply the rotation to the image which is stored in the image DB of the photosite 107. In addition, the controlling unit 201 records the number of rotations and the rotation angle, and may also apply the rotation angle which has been recorded when the original image data has been downloaded from the photosite 107, to the original image data. The deletion button 1005 is a button for deleting the image data, and by being depressed, deletes the data of the thumbnail 1008 and deletes the original image data of the thumbnail 1008 from the image DB 109. Specifically, the controlling unit 201 transmits the discrimination information against the image data of the thumbnail 1008, for instance, the image ID, to the photosite 107 through the Internet 106. The controlling unit 108 of the photosite 107 deletes the image data corresponding to the image ID which the controlling unit 108 has received from the image DB 109. After the image data has been deleted, the controlling unit 201 may display the detailed view 1000 of the image, which has arranged image data just prior to the displayed image data, or may return the view to the view 700 of the list of the images in the group, which is the transition origin. The method is not limited to this operation.

The rating setting region 1006 is a region for setting the rating to the image data, and sets the rating value for the image data by the depression of the star icon. In the present embodiment, the number of the star icons increases sequentially from the left; and the rating value, in other words, the number of the star icons can be changed by the depression of another star icon, and the set rating value can be canceled by the depression of the another star icon. In addition, an exclusion function is also provided that does not put the star icon, but the method for designating the rating value is not limited to the present invention.

The detailed information display button 1007 is a button for displaying the detailed information of the image data, and when the button is depressed, the attribute information of the image data is thereby displayed, which is displayed in the detailed view 1000 of the image, as is illustrated in FIG. 10B. The attribute information includes image information 1011, photographing information 1012 and position information 1013, and each of the information is displayed in a tab form. In FIG. 10B, the image information 1011 displays an image name 1014, an image name editing button 1015, the number of browses 1016, a tag display region 1017, a tag editing button 1018, and an album display region 1019. The image name 1014 is an image name of the image data that is displayed in the display region 1021 of the images as the thumbnail 1008. The image name editing button 1015 is a button for editing the image name 1014. The number of times of browses 1016 is the number of how many times invited users have browsed the image. The tag display region 1017 is a region for displaying the tag that is attached to the image data of the thumbnail 1008. The tag editing button 1018 is a button for editing the tag. The album display region 1019 is a region for displaying a list of images in the album to which the image data of the thumbnail 1008 belongs. Incidentally, the displayed content and the display method of the attribute information are not limited to them.

The thumbnail 1008 is a thumbnail of an image that has been selected in the view 700 of the list of the images in the group in FIG. 9A, and is displayed with visibility that is suitable for the type of the information processing apparatus 200, for instance, a PC, a smart phone, and the like. The display region 1009 of the images in the group is a region for displaying a list of the image data that belong to the same group, and the image data are arranged which belong to the same group so that a contextual relation can be grasped between the image data which is displayed as the thumbnail 1008 and other image data. The image switching button 1010 is a button for switching the image data that is displayed in the display region 1021 of the images to the image before or after the image data. When the image switching button 1010 is depressed, the image data that is displayed in the display region 1021 of the images is thereby switched in order of the image data before or after the image data, in other words, in order of image data that are displayed in the display region 1009 of the images in the group. In FIG. 10A, the image data that is displayed in the display region 1021 of the images is the last image data in the group, and accordingly FIG. 10A illustrates a state in which the image switching button 1010 for switching the image data to the next image data is not displayed, which exists in the right side of the view of the detailed view 1000 of the image. In addition, in the case of the smart phone, the tablet terminal and the like, it is general that the user moves the image data to left and right by swiping of the touch screen, and accordingly it is also possible that the image switching button 1010 is not arranged and the user switches the image data as a response of a swiping operation.

The controlling unit 201 responses to such an operation that the user selects an image in the view 700 of the list of the images in the group and returns the view to the last view from the detailed view 1000 of the image, or to an operation of switching the image by depressing the image switching button 1010 in the detailed view 1000 of the image, and repeatedly executes the step S310. Specifically, the controlling unit 201 implements the overwriting of the variable N with the image ID of the image data that has been displayed in the detailed view 1000 of the image, or with the image ID of the image data that has been switched in the detailed view 1000 of the image. Specifically, in order to set the image that has been finally browsed in the detailed view 1000 of the image, as a target image, the controlling unit 201 stores the image ID of the image data that has been finally displayed in the display region 1021 of the images of the detailed view 1000 of the image, as the variable N. In addition, also when the image is switched by the deletion of the image data, the controlling unit 201 overwrites the variable N with the image ID of the switched image data. When the user has not displayed the detailed display of any image data, in the view 700 of the list of the images in the group, the controlling unit 201 regards the image that is displayed in the head of the view 700 of the list of the images in the group as the target image, and stores the image ID for the variable N. Incidentally, in the present embodiment, the controlling unit 201 stores the image ID for the variable N, while regarding the image that has been finally displayed as the target image, but the method for selecting the target image may be any method as long as the target image can be narrowed down to one.

When there has not been an operation of displaying the detailed view of the image (step S309: No), the controlling unit 201 determines that there is no new image ID to be assigned to the variable N, and determines whether or not the image data has been grouped in the view 700 of the list of the images in the group (step S312). When the image data has been grouped in the view 700 of the list of the images in the group, in other words, when an item has been selected in the grouping menu 501 (step S312: Yes), the controlling unit 201 displays the result of grouping according to the selected item. Processing of the grouping is the same as that in the step S305. Then, the controlling unit 201 generates view data for the view 600 of the group list, in which the grouped image data are arranged, and displays the view 600 of the group list on the display unit 211 (step S306). Thus, the controlling unit 201 performs the processing of the grouping in the steps S306 to S311 again. By this processing, the controlling unit 201 can narrow down images by grouping in multistage.

When the image data has not been grouped in the view 700 of the list of the images in the group (step S312: No), the controlling unit 201 determines the operation in the list 703 or the list 1020 (step S313). In the step S313, the controlling unit 201 determines whether or not an operation has been performed for the list 703 in the view 700 of the list of the images in the group, or for the list 1020 in the detailed view 1000 of the image. In the present embodiment, the controlling unit 201 determines whether or not the operation of returning to the view 400 of the list of the images has been performed by the operation for the list 703 or the list 1020 by the operation of the user. Specifically, the controlling unit 201 determines whether or not the operation of returning in the list 703 or the list 1020 has been performed, in other words, an operation of selecting any item from among the histories of the search condition has been performed which the list 703 or the list 1020 shows. In a case where any item is selected in the list 703 or the list 1020, the item is canceled from the search condition of the present grouping, the searching result in which the search range has been widened results in being displayed in the view of the list of the images, and the view returns to a state before the item has been added to the search condition. When there has been an operation of returning in the list 703 or the list 1020 (step S313: Yes), the controlling unit 201 displays the view 400 of the list of the images, which contains the image ID that is stored in the variable N, in the view 400 of the list of the images (step S314). In the step S314, the controlling unit 201 generates display data for the view 400 of the list of the images, in which a part of image data is arranged that contain the image data having the image ID stored in the variable N and are contained in the searching result in which the search range has been widened, and displays the view 400 of the list of the images on the display unit 211. Specifically, the controlling unit 201 arranges the image data that has the image ID stored in the variable N, at a position which the user can visually identify the image when the view 400 of the list of the images has been displayed.

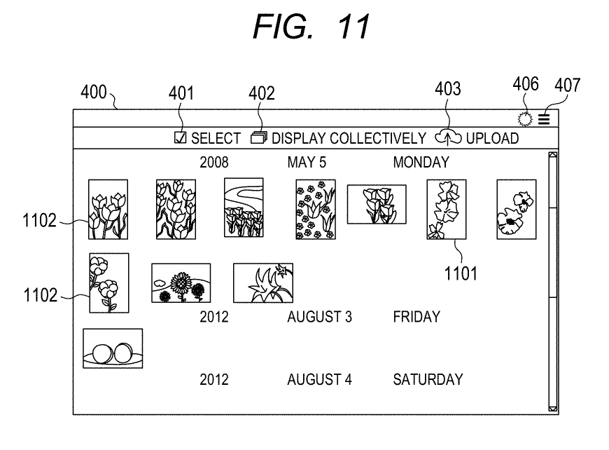

FIG. 11 is a view illustrating one example of view displays according to the present embodiment. Specifically, FIG. 11 is one example of a view 400 of a list of images, which has returned from the list 703 of the view 700 of the list of the images in the group, according to the present embodiment. FIG. 11 illustrates a view 400 of a list of images when the image ID of the image of the thumbnail 1008 illustrated in FIG. 10A has been stored in the variable N. In the view 400 of the list of the images, the image data which has been displayed in the thumbnail 1008 is displayed within the display range of the view 400 of the list of the images, as the thumbnail 1101. In addition, the thumbnail 1102 of the image data on the same photographing day as that of the image data which is displayed in the thumbnail 1101 is displayed together with the thumbnail 1101. Thus, in a case where a user has narrowed down the image data in the multistage, has browsed the detail of the image data and has returned to the list of the images, peripheral images containing the target image, in other words, the target image and the image in the same group as the target image are displayed within the display range of the view 400 of the list of the images. Thereby, the user can easily utilize the image data. Methods of utilizing the image includes, for instance: creating an album with the use of the target image and the peripheral image, and disclosing the album to the third party; and ordering printing, and developing the image. However, the methods are not limited the above methods.

On the other hand, in the case of an operation other than an operation of selecting the list 703 or 1020, for instance, in the case of the operation of returning to the previous view by an operation of switching the mode of the view, or the like (step S313: No), the controlling unit 201 displays the view 400 of the list of the images in default image arrangement (step S315). In a step S315, the controlling unit 201 creates display data for a view 400 of a list of images so as to be displayed in a predetermined image arrangement illustrated in the view 400 of the list of the images in FIG. 4A, without using the value of the variable N, and displays the view 400 of the list of the images on the display unit 211. Thereby, a route for returning to a previous view is secured in a case where the user does not like the image display that has been narrowed down to the target image.

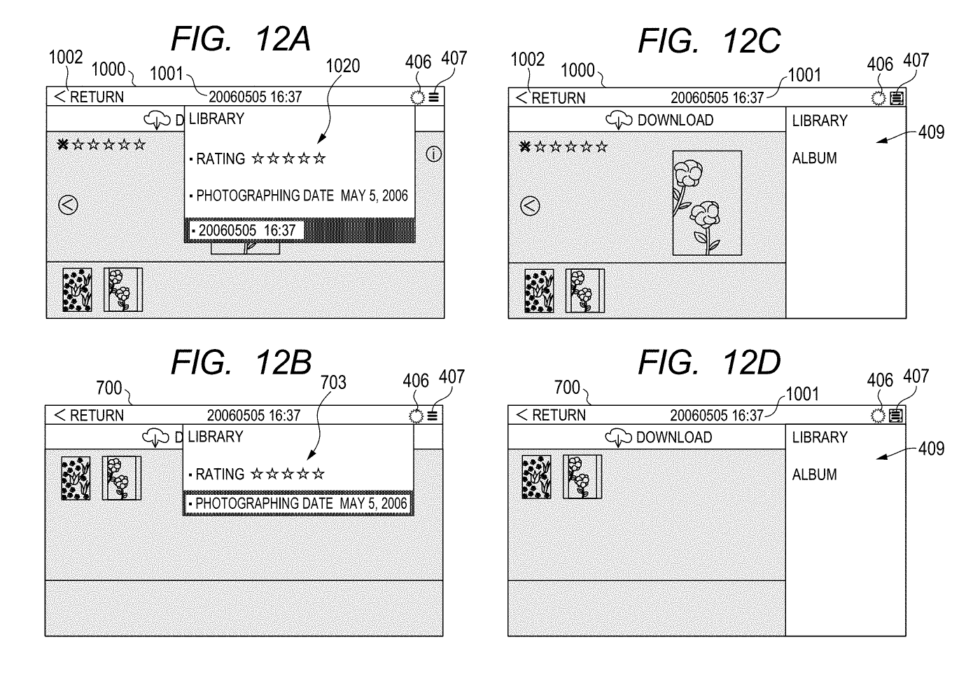

The above description will be described in detail below with reference to FIGS. 12A to 12D. FIGS. 12A to 12D are views each illustrating one example of view displays according to the present embodiment. FIG. 12A is a view illustrating one example of view displays in a case where the view returns to a previous view from the detailed view 1000 of the images with the use of the list 1020, according to the present embodiment. FIG. 12B is a view illustrating one example of view displays in a case where the view returns to a previous view from the view 700 of the list of the images in the group with the use of the list 703, according to the present embodiment. FIG. 12C is a view illustrating one example of view displays in a case where the view returns to a previous view from the detailed view 1000 of the images with the use of the library/album menu 409, according to the present embodiment. FIG. 12D is a view illustrating one example of view displays in a case where the view returns to a previous view with the use of the library/album menu 409 of the view 700 of the list of the images in the group, according to the present embodiment. As are illustrated in FIG. 12A and FIG. 12B, the items which are used for grouping are displayed as the history in the lists 703 and 1020. The image processing unit can display image data corresponding to the image ID that is stored in the variable N in the view 400 of the list of the images, by using the above items. In addition, the view can return to the view 400 of the list of the images by switching of the view with the use of the library/album menu 409, as are illustrated in FIG. 12C and FIG. 12D. In the case where the view returns to the view 400 of the list of the images with the use of the library/album menu 409, all of the images are displayed in the view 400 of the list of the images, in the default image arrangement.

Thus, in the present embodiment, the information processing apparatus narrows down the image data in the multistage, stores the image ID of the browsed image data in the variable N, and when the search condition has been canceled, arranges and displays the image data of the image ID stored in the variable N, in the display range of the view. Thereby, even after the information processing apparatus has narrowed down the contents on a search condition and then has canceled the search condition, the target contents are displayed in the view, and accordingly the user can easily utilize the target content.

### Other Embodiments

The description of the present embodiment shall be finished with the above, but the present invention is not limited to the above described embodiments, and can be modified in various ways in such a range as not to deviate from the scope of the invention. For instance, in the above described embodiment, the processing of returning from the view 700 of the list of the images in the group to the view 400 of the list of the images has been described above, but similar processing can also be adapted to a case where a view returns to the view 400 of the list of the images from the detailed view 1000 of the image. In addition, in the present embodiment, the processing has been described above in which a view returns to the view 400 of the list of the images from the view 700 of the list of the images in the group, which has been narrowed down by the two stages, but the processing is not limited to the above processing. The present invention can be applied also to a case, for instance, where the view returns to the view 400 of the list of the images from the view 700 of the list of the images in the group, which has been narrowed down in the multistage and is a deep layer, or from the detailed view 1000 of the image, to a case where the view returns to the view 700 of the list of the images in the group, which is being narrowed down, from a deep layer that has been narrowed down in the multistage, and to the like. In addition, the present invention can be adapted also to a case where the view returns to any narrowing down stage, such as a case where the view returns to the view 400 of the list of the images from the view 700 of the list of the images in the group, which is being narrowed down. Thus, the information processing apparatus can provide each of two routes of: a returning way for the view, in which the user aims the target image; and a returning way for the view, in which the user does not aim the target image.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-256997, filed Dec. 28, 2015, which is hereby incorporated by reference herein in its entirety.

What is claimed is:

1. An information processing apparatus comprising:
a processor; and
a memory storing a program which, when executed by the processor, causes the information processing apparatus to:
arrange and display a part of first contents out of the plurality of contents, which are contained in a first searching result that has been searched based on a first search condition, on a screen;
arrange and display a part of second contents out of the first contents contained in the first searching result, which are contained in a second searching result that has been searched based on a second search condition, on the screen;
select at least one out of the second contents which are contained in the second searching result;
arrange and display a part containing the selected contents, out of the first contents which are contained in the first searching result, on the screen, if the second search condition is canceled; and
update contents which are arranged on the screen, in response to scrolling.

2. The information processing apparatus according to claim 1, wherein the program when executed by the processor further causes the information processing apparatus to arrange and display a part of the first contents that contain contents which are in a head, out of the plurality of selected contents, on the screen.

3. The information processing apparatus according to claim 1, wherein the program when executed by the processor further causes the information processing apparatus to arrange and display a part of the first contents that contain contents which have been finally selected, out of the plurality of selected contents, on the screen.

4. The information processing apparatus according to claim 1, wherein the program when executed by the processor further causes the information processing apparatus to arrange and display at least one content of the selected contents so that the content is displayed on the screen in a larger size than that of a content which is arranged before further selecting, when the content is further selected from the first contents or the second contents.

5. The information processing apparatus according to claim 1, wherein the program when executed by the processor further causes the information processing apparatus to store the first search condition or the second search condition in a storage unit, wherein when the first search condition is selected from among the stored search conditions, the second search condition is thereby canceled.

6. An information processing method comprising:
arranging and displaying a part of first contents out of the plurality of contents, which are contained in a first searching result that has been searched based on a first search condition, on a screen;
arranging and displaying a part of second contents out of the first contents contained in the first searching result, which are contained in a second searching result that has been searched based on a second search condition, on the screen;
selecting at least one out of the second contents that are contained in the second searching result; and
arranging and displaying a part containing the selected contents, out of the first contents that are contained in the first searching result, on the screen, if the second search condition is canceled; and
updating contents that are arranged on the screen, in response to scrolling.

7. A non-transitory computer-readable recording medium storing a readable program for operating a computer to execute an information processing method comprising:
arranging and displaying a part of first contents out of the plurality of contents, which are contained in a first searching result that has been searched based on a first search condition, on a screen;
arranging and displaying a part of second contents out of the first contents contained in the first searching result, which are contained in a second searching result that has been searched based on a second search condition, on the screen;
selecting at least one out of the second contents that are contained in the second searching result; and
arranging and displaying a part containing the selected contents, out of the first contents that are contained in the first searching result, on the screen, if the second search condition is canceled; and
updating contents that are arranged on the screen, in response to scrolling.
